(19) United States
(12) Patent Application Publication
(10) Pub. No.: US 2009/0121391 A1
(43) Pub. Date: May 14, 2009

(54) METHOD AND SYSTEM FOR PACKAGING OF MEDICAL DEVICES INCLUDING SHAPE MEMORY POLYMERS

(76) Inventors: Kenneth A. Gall, Altanta, GA (US); Kurt Jacobus, Atlanta, GA (US)

Correspondence Address: GREENBERG TRAURIG, LLP, 1200 SEVENTEENTH STREET, SUITE 2400, DENVER, CO, 80202, US

(21) Appl. No.: 11/938,578

(22) Filed: Nov. 12, 2007

(51) Int. Cl. B29B 13/00

(52) U.S. Cl. 264/345

(57) ABSTRACT

Methods and systems are described which allow medical devices containing shape memory polymers to be stored and/or transported without temperature control. Temperature control can be used to inhibit activation of shape memory polymers. Embodiments of methods described herein include activating shape memory polymers while within packaging which inhibits shape change due to activation. Packaging systems are also described herein.

### BACKGROUND

Medical devices are packaged for many reasons, including protecting the medical device in a sterile environment before the medical device comes in contact with a patient. Packages for medical devices are often placed around the medical device, or the medical device is placed within the package. Commonly, the medical device remains in the package from the manufacturer until the medical device is ready to be used within a patient. Packages for medical devices may protect medical devices and keep them sterile during storage and transportation until the use of the medical device within a patient.

### SUMMARY

Methods and systems are described which allow medical devices containing shape memory polymers to be stored and/or transported without temperature control. Temperature control can be used to inhibit activation and recovery of shape memory polymers. Embodiments of methods described herein include activating shape memory polymers while within packaging which designed to restrict shape change due to activation. Packaging systems are also described herein.

Embodiments of methods and systems are described herein for constraining devices containing a shape memory polymer (SMP) in a package. Methods and systems described herein also apply to medical devices which are entirely or partially composed of an SMP and which must be kept sterile. SMPs and medical devices containing SMPs may change shape toward a memorized or recovered shape upon activation of the shape memory element. Methods and systems are described herein for utilizing packages that constrain SMPs and/or medical devices containing SMPs to a particular shape, despite activation of the SMP.

In one aspect, the disclosure describes a method of preparing and deploying in surgery a shape memory polymer. The method includes installing into a package a shape memory polymer in a first shape at a first storage temperature below a transition temperature of the shape memory polymer. The method further includes, after installing, allowing the shape memory polymer to approach the transition temperature. The method further includes, constraining by the package the shape memory polymer in the first shape, and inserting the shape memory polymer in the first shape at a second storage temperature into a patient at an insertion site in the patient with an insertion temperature greater than the second storage temperature. The insertion temperature may be below the transition temperature.

The method may further include, after inserting, heating the shape memory polymer while inside the patient. Heating may be selected from flooding the insertion site with a saline bath, contacting the shape memory polymer with an external heating element, and exposing the shape memory polymer to electromagnetic radiation. The first storage temperature may be different from the second storage temperature.

The method may further include inducing recovery of the shape memory polymer into a second shape while in the patient, thereby fixing the shape memory polymer relative to a bone of the patient. The method may further include deforming the shape memory polymer, wherein the deforming and the installing are performed as a single operation.

In another aspect, the disclosure describes a method of aging a shape memory polymer in a medical device. The method includes installing a medical device containing a shape memory polymer in a deformed shape into a package adapted to constrain the medical device against shape change during activation of the shape memory polymer. The method also includes aging the shape memory polymer in the package for an aging period, and during the aging period, inducing recovery of the shape memory polymer within the package. The method also includes, after aging the shape memory polymer, removing the medical device from the package. The method also includes inducing recovery of the shape memory polymer in a patient.

The method may further include inducing recovery of the shape memory polymer within the package includes heating the shape memory polymer. The method may further include, after inducing recovery of the shape memory polymer within the package and before removing the medical device from the package, cooling the shape memory polymer to below an activation temperature of the shape memory polymer. The method may further include placing the medical device in the patient.

In another aspect, the disclosure describes a method of providing a shape memory polymer for use at a surgery site. The method includes installing a shape memory polymer which is in a deformed shape into a package adapted to prevent the shape memory polymer from changing into a recovered shape if the shape memory polymer approaches a transition temperature of the shape memory polymer. The method further includes inducing recovery of the shape memory polymer in the package. The recovered shape may require a deformation before use during a surgical procedure.

The method may further include sterilizing the shape memory polymer, and sterilizing the package. The method may further include, after installing the shape memory polymer in the package, sterilizing the shape memory polymer, and sterilizing the package.

The method may further include removing the shape memory polymer from the package. The method may further include after removing the shape memory polymer, placing the shape memory polymer in a patient. The method may further include inducing recovery of the shape memory polymer while in the patient into a third shape which conforms to a soft tissue and to a bone of the patient.

Removing the shape memory polymer from the package may include operating a release mechanism included in the package. Operating the release mechanism may open the package, at least partially. Operating the release mechanism may remove contact between at least part of the package and at least part of the shape memory polymer. Operating the release mechanism may include applying an incremental operating force to a part of the release mechanism.

Inducing recovery of the shape memory polymer may include allowing the shape memory polymer to approach a transition temperature of the shape memory polymer.

The method may include adjusting the package to conform to the shape memory polymer in the first shape. Adjusting the package may be performed before inducing recovery. Adjusting the package may include collapsing the package against the shape memory polymer. Adjusting the package may include tightening an adjustable element of the package. Deforming the shape memory polymer and the adjusting the package may be performed as a single operation.

The method may include deforming the shape memory polymer within the package. The package after adjustment may contact a first portion of the shape memory polymer in the first shape. The package may define a surgery installation shape, and the method may further include inducing recovery of the shape memory polymer into the surgery installation shape.

In another aspect, the disclosure describes a kit including a first shape memory polymer in a deformed shape, and a package adapted to constrain the first shape memory polymer to prevent the first shape memory polymer from changing into a recovered shape different from the deformed shape if the first shape memory polymer is activated.

The first shape memory polymer may be within the package. The kit may include a second shape memory polymer. The second shape memory polymer may be within the package. The second shape memory polymer may be in an alternate deformed shape different from the deformed shape of the first shape memory polymer.

The package may be further adapted to constrain the second shape memory polymer to prevent the second shape memory polymer from changing into a second recovered shape different from the alternate deformed shape if the second shape memory polymer is activated. The alternate deformed shape may be a scaled version of the deformed shape of the first shape memory polymer. The alternate deformed shape may be scaled along one dimension of the deformed shape of the first shape memory polymer.

The kit may include a sterile tool for extracting from the first shape memory polymer from within the package. The sterile tool may be selected from tools including a hex key, and a lever. The sterile tool may be adapted for use in installing the first shape memory polymer into an installation site in a patient.

### A BRIEF DESCRIPTION OF THE DRAWINGS

FIG. 1A shows a cross-section view of an embodiment of a package which is designed to allow a shape memory element to be activated within a package, without a commensurate shape change of the medical device.

FIG. 1B shows a cross-section view of an embodiment of a package which is designed to allow multiple shape memory elements to be activated within a package, without a commensurate shape change of the medical devices.

FIG. 2 shows a flow chart of an embodiment of a method for transporting a medical device including a shape memory element for placement within a patient.

FIG. 3 shows a flow chart of an embodiment of a method for storing and transporting a shape memory element under constraint.

FIG. 4A shows experimental data of free-strain recovery of shape memory polymers with varying durations of constraint.

FIG. 4B shows experimental data of constrained recovery of shape memory polymers with varying durations of constraint.

### DETAILED DESCRIPTION

The following description of various embodiments is merely exemplary in nature and is in no way intended to limit the disclosure. While various embodiments have been described for purposes of this specification, various changes and modifications may be made which will readily suggest themselves to those skilled in the art, and which are encompassed in the disclosure.

Prior art methods and systems for packaging shape memory polymers (SMPs) and medical devices containing SMPs do not include teachings of packages which are able to constrain SMPs from changing shape during recovery. For example, the prior art teaches deforming an SMP (e.g., an SMP within a medical device) at a temperature above a transition temperature for the SMP, then cooling the SMP to a storage temperature which is below an activation temperature at which the SMP will begin to recover. The storage temperature is chosen which ensures activation (even partial activation) due to temperature does not occur, and therefore inhibits recovery. An often-proclaimed advantage of shape memory polymers over other deformable materials is the ability to control shape change in the shape memory polymers through temperature control.

An example of an SMP is a polymer composition comprising poly-ethylene glycol di-metacrylate (PEG-DMA) and methyl methacrylate (MMA). Another example of an SMP is a polymer composition comprising PEG-DMA and tert-butyl acrylate (tBA). Such polymers are created by polymerizing monomoers such as PEG-DMA (e.g., OHCH₂(CH₂OCH₂)ₙCH₂OH-DMA), and MMA (e.g., CH₂:C(CH₃)COOCH₃). Also included in the polymer composition was a sufficient amount of an appropriate photo-initiator.

In an embodiment, SMPs may be photopolymerized from tBA, a di-functional monomer, with PEG-DMA, a tetra-functional monomer acting as a crosslinker. A di-functional monomer may be any compound having a discrete chemical formula further comprising an acrylate functional group that will form linear chains. A tetra-functional monomer may be any compound comprising two acrylate, or two methacrylate groups. A crosslinker may be any compound comprising two or more functional groups (e.g., acrylate, methacrylate). Also, ethyleneglycol, diethyleneglycol, and triethyleneglycol based acrylates are forms of polyethyleneglycol based acrylates with one, two, or three repeat units.

A functional group may refer to any reactive group. For example, a functional group may be an acrylate group. A mono-functional molecule refers to a molecule having one functional group (e.g., an acrylate group, a methacrylate group). A multi-functional molecule may have two or more functional groups.

In one embodiment, the SMP material is a photo-initiated network comprising tBA, PEG-DMA, and 2,2-dimethoxy-2-phenylacetephenone as a photo-initiator. Those with skill in the art will recognize that other polymerization techniques, such as thermal radical initiation, can be used for polymer fabrication.

The term “recovery” as used herein refers to the changes which an SMP undergoes based on activation. Recovery may include shape change of the SMP and/or a development of a force between the SMP and a constraint (e.g., a package, the SMP's surroundings). In one embodiment, recovery includes only exertion of force against a constraint without any commensurate shape change. In another embodiment, recovery includes shape change free from constraint, also called free-strain recovery. In another embodiment, shape change may occur to an extent, and further shape change may be limited by a constraint, and therefore forces may be developed against the constraint.

In embodiments of the methods and systems described herein, an SMP may undergo multiple recoveries due to multiple activations. For example, an SMP may be constrained through multiple uncontrolled temperature cycles (each of which causes a recovery cycle). Then the SMP may be removed from its constraint and recovery may be initiated within a patient, with recovery including both shape change and the exertion of force against a part of the patient.

The term “activation,” as used herein, refers to inducing recovery in the SMP. Activation (and induced recovery) may be avoided in temperature-activated SMPs by keeping the SMP below the activation temperature until shape change of the material is desired. Such an SMP may be activated through heating the material to near the transition temperature of the SMP.

A material which is activated has sufficient free energy such that molecules of the material are driven to approach a higher-entropy configuration. However, the even though molecules in a material may be driven toward a higher-entropy configuration, and a commensurate shape change, that higher-entropy configuration may not be obtained. Instead, a constraint may be applied to the material and the material may generate a force against the constraint.

Depending on the constraints applied to the material, recovery caused by activation can include shape change and/or generation of forces against a constraint. For example, even though activation may otherwise drive a change in molecular configuration (and thereby a shape change), that shape change may be inhibited by the application of external constraints.

Transition temperatures for SMPs are commonly defined by changes in macroscopic material properties, such as changes in the modulus of the SMP (e.g., an inflection point in a modulus curve, a midpoint of a transition in a modulus curve). The modulus of an SMP may be measured using a dynamic modulus analysis setup, using standard techniques known to those with skill in the art.

An activation temperature of an SMP is a temperature above which the SMP is significantly activated (e.g., which causes significant recovery in the SMP). An SMP need not reach or exceed its transition temperature for activation to occur. For example, activation of an SMP may occur in a temperature range below the transition temperature of the SMP. In SMPs with high cross-linking density, the activation temperature may be about 30 degrees Celsius below the transition temperature and the SMPs may be designated as having a broad transition (e.g., a broad range of temperatures in which recovery significantly occurs). In SMPs with moderate cross-linking density, the activation temperature may be about 20 degrees Celsius below the transition temperature and the SMPs may be designated as having a moderate transition. In SMPs with low cross-linking density, the activation temperature may be about 10 degrees Celsius below the transition temperature and the SMPs may be designated as having a narrow transition. In SMPs with very low cross-linking density, the activation temperature may be about 3 degrees Celsius or fewer below the transition temperature and the SMPs may be designated as having a very narrow transition.

The rate of recovery may be determined by how close an SMP is to its activation temperature, which is related to the SMP's transition temperature, as described further herein. Depending on the temperature of an SMP and its activation temperature, the rate of the recovery in the material may be quite slow. Significant activation (e.g., for the purposes of determining an activation temperature) may be considered activation causing recovery of about 20% of stored strain in a constraint-free environment (described further below) within a time period of about 2 hours. Slight activations may occur below the activation temperature and result in a slower recovery rate.

Uncontrolled shape change prior to use, such as uncontrolled shape change during transport or storage, may render the medical device less useful for installation within a patient. Even a slight activation rate in an SMP may result in an undesirable shape change of the SMP. A slight activation (e.g., due to a slight rise in temperature) that is allowed to occur without constraint over a long period of time (e.g., storage, transportation) can produce large undesirable shape changes. An SMP subjected to even slight recovery through shape change over a period of time renders the SMP less useful or even entirely useless.

Therefore, one approach to preventing even slight activation occurring prematurely is controlling the temperature of SMPs during packaging, during transportation, and during other times between the deformation of the SMP and the use of the SMP. The prior art does not teach that an SMP could be useful after uncontrolled temperature excursions near or above the transition temperature of the SMP. Instead, the conventional wisdom teaches that all forms of activation are to be avoided after the desirable deformation has been imparted onto the SMP and the deformed shape has been locked into the SMP through cooling of the SMP to below aconservative storage temperature.

The methods and systems described herein may be used to control and/or minimize shape change without having to minimize activation of the SMP. For example, an SMP may be processed, packaged, and subsequently be subjected to temperature variations causing activation of the SMP without causing shape change to the detriment of the utility of the SMP. For example, contrary to the teachings of prior art, a method is described herein in which an SMP is packaged in a deformed state, then the SMP is allowed to approach the transition temperature for the SMP (e.g., during transportation). The SMP may then be cooled before the SMP is removed from the package and placed within a patient. The prior art does not teach such an SMP or medical device containing an SMP that is able to withstand temperature deviations to near a transition temperature without significantly changing shape due to the activation caused by the temperature excursion.

Methods and systems are described herein which hold an SMP (e.g., comprising an element within a medical device) in a deformed shape despite the activation of the SMP. For example, a package, or portion thereof, may be designed to withstand an expansive force from an activated SMP exerted on its inner walls. As another example, a package may be designed to withstand an expansive force from the recovery of an SMP on a portion of the inner walls and other portions of the inner walls. Portions of packages may be designed for other purposes, such as the purpose of supporting inner walls which withstand expansive forces and/or the purpose of keeping the medical device sterile. It will be understood, however, that current packages which are designed for storage and transportation under temperature control are not designed to withstand these forces. Indeed, such a design of prior art packages would constitute a drastic over-building of the packages. Current packages are designed primarily to ensure that a medical device remains sterile, to protect the device from physical damage during transport (e.g., via cushioning).

The methods and systems described herein specifically prepare for uncontrolled and premature activation of an SMP. In the methods and systems described herein, shape change is limited and/or controlled during activations that are uncontrolled and/or premature. Some methods include operations whereby a recovery of the SMP occurs due to exposure to uncontrolled temperature environments. Some methods include active heating cycles while an SMP is within a package (e.g., to initiate a recovery including a desired shape change).

In some embodiments, shape change is minimized or eliminated via constraints of packaging. In other embodiments, shape change is allowed to occur into a predetermined shape. For example, the predetermined shape may be a desirable shape for implantation into a patient. The effects of aging an SMP under constraint are described herein, including the benefits of storing an SMP under constraint (e.g., a package exerting a force on the SMP) for a period of time.

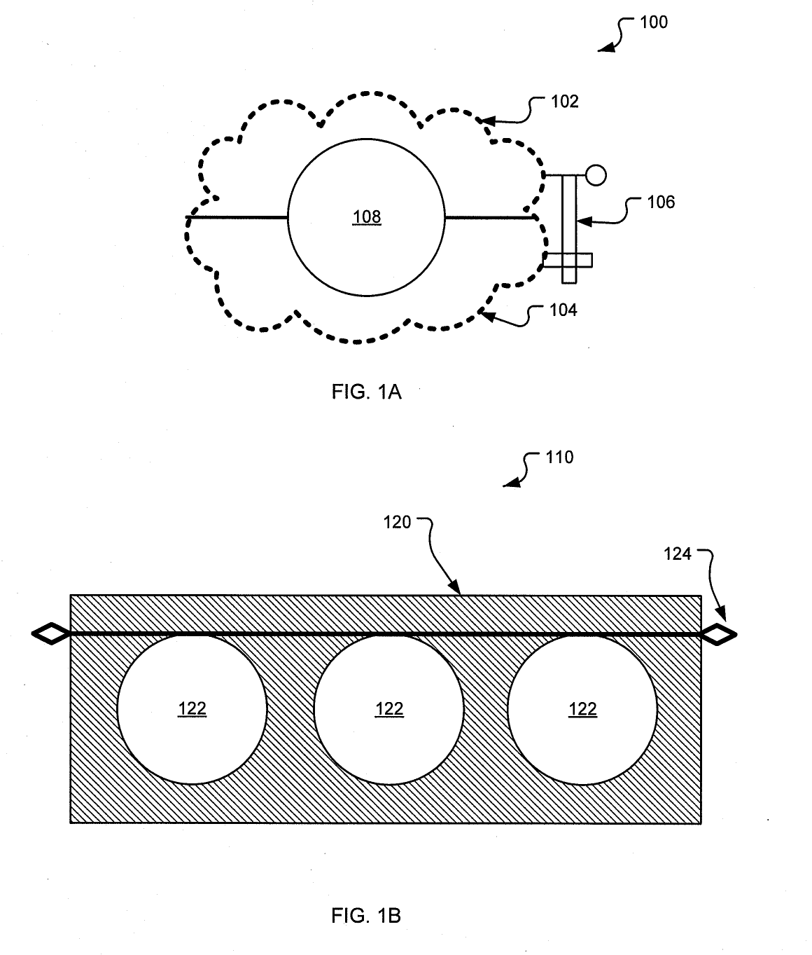

FIG. 1A shows a cross-section view of an embodiment of a package 100 which is designed to allow a shape memory element to be activated within a package, without a commensurate shape change of the medical device. The package 100 includes two mating halves 102, 104 with a locking mechanism 106 for locking the halves together. When the package 100 is closed, there is a cavity 108 defined by the inner walls of the two halves 102, 104. In the embodiment shown, a general outer surface of the package 100 is represented generally by a dashed line. Any appropriate shape of the outer surface may be used. In one embodiment, the cavity 108 is substantially cylindrical. In another embodiment, the cavity defines a threaded shape (e.g., like a screw). In yet another embodiment, the cavity defines another shape, such as a dog-bone shape, a tapered shape, or a shape with ridges. Other shapes are also possible and the cavity 108 may have any desired shape. The cavity 108 may have an axis (e.g., as shown normal to the cross-section view of FIG. 1A) or may not have an axis. The cavity axis (if any) may be normal to the direction in which the two halves 102, 104 of the package open (as shown) or may be askew from that direction. The package 100 may include closures at either end of the cavity 108, thereby creating a sealed cavity.

FIG. 1B shows a cross-section view of an embodiment of a package 110 which is designed to allow multiple shape memory elements to be activated within a package, without a commensurate shape change of the medical devices. The package 110 includes a single body element 120 such as a solid body with cavities. The single body element 120 defines multiple cavities 122 by the inner walls of the single body element. The single body element 120 is an embodiment of a package which can store and transport a kit of medical devices in the multiple cavities while preventing shape change in the medical devices.

Though the cavities shown in FIG. 1B are similarly-sized cylinders, the multiple cavities 122 may be of different sizes and shapes (such as the cavities described above). In one embodiment, one cavity 122 is substantially cylindrical. In another embodiment, one cavity defines a threaded shape (e.g., like a screw). In yet another embodiment, one cavity defines another shape, such as a dog-bone shape, a tapered shape, or a shape with ridges.

Single body element 120 includes an embodiment of a destructive element 124 for opening the package 110. The embodiment of the destructive element 124 shown is a pull cord which ruptures, cuts, damages, and/or otherwise destroys part of the single body element 120, allowing access to medical devices stored in cavities 122. As shown in FIG. 1B, the destructive element 124 can be designed to allow access to multiple medical devices. In another embodiment, a plurality of destructive elements can allow access to the plurality of medical devices in the kit. For example, each destructive element can allow access to one of the multiple medical devices.

In one embodiment, a tool (not shown) can be included with the package to aid in extraction of the medical devices from the package. In another embodiment, the tool can be used to place the medical device into a patient. For example, the tool can be a hex key which allows a surgeon to pry or unscrew a medical device out of the package with the hex key and also to place the device into the patient with the hex key. The tool can be included inside the package and may serve as a destructive element within the package, aiding the opening of the package by its removal from the package. Alternatively, the tool can be attached to the package, included alongside the package, and/or otherwise included with the package.

Packages 100, 120 may be incorporated into other packaging, for example to protect against damage from transport. For example, a package 100, 120 may be surrounded by a cushioning substance and placed into a carrier. In addition, multiple packages 100, 120 may be included within another outer package for ease of shipping or for the purposes of providing an array of medical devices from which a surgeon may choose a medical device for use within a patient. As another example, a package 100, 120 may provide constraint to control shape change while another package (e.g., a seal, a wrap) may provide a sterile barrier.

Each cavity 108, 122 may not be filled by the medical device when the medical device is installed in the cavity. For example, the medical device containing an SMP may be installed in a shape which does not completely fill the cavity 108, 122. The SMP may be activated and may expand to fill part of the cavity 108, 122. The SMP, after activation, may recede to leave part of the cavity unfilled by the medical device.

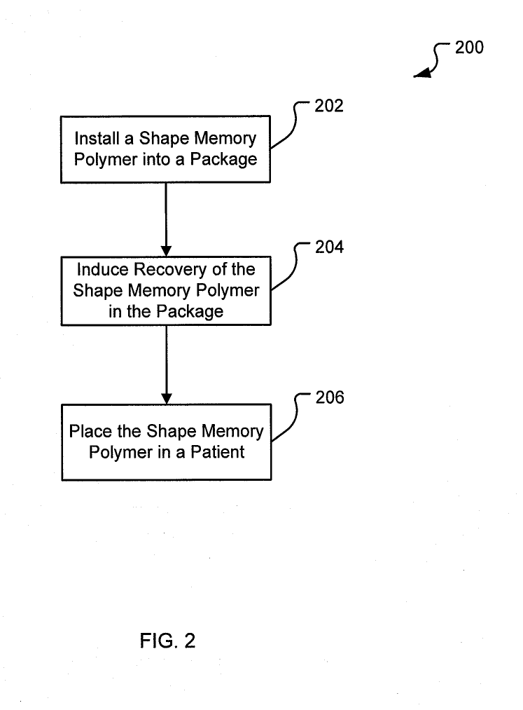

FIG. 2 shows a flow chart of an embodiment of a method 200 for transporting a medical device including a shape memory element for placement within a patient. The method 200 will be described in further detail below through different embodiments. In other words, in some embodiments, the method 200 may include additional steps or operations.

The method includes installing 202 the SMP into a package. The SMP may be included in a medical device, and installing 202 the SMP in the package should be understood to encompass installing the medical device in the package. The installing operation 202 may occur after the SMP device is manufactured or as part of the manufacturing of the medical device. Installing 202 can include inserting, extruding, sliding, depositing, and/or delivering the SMP within the package. The package, as described further herein, is designed and built to withstand forces caused by activation of the SMP. Installing 202 the SMP may include all of the steps required to close, assemble, and manipulate the package so that the package can withstand the forces of activation. For example, a package 100 (in FIG. 1A) which requires the closing of two halves 102, 104 of the package followed by the locking of a locking mechanism 106 before the package is able to keep its two halves closed against forces (e.g., activation forces, stresses caused by deformation) exerted against the inner walls of the package.

In one embodiment, the SMP may be kept at a controlled temperature (e.g., a storage temperature) during the process of installing 202 until the package is secured around the SMP, in order to avoid activation of the SMP and commensurate recovery. For example, the installation process 202 may require a number of steps to securely constrain the SMP within the package (such as the package in FIG. 1A). As another example, the package may be made of a single piece or otherwise may be in a constraint-providing configuration before the SMP is inserted (such as the package in FIG. 1B). As noted above, some packages may be able to cause the deformation of the SMP through insertion into the package.

In another embodiment, the SMP is installed 202 while it is at a deformation temperature. For example, the SMP may be deformed through the act of placing the SMP into the package, such as through extruding the SMP into the package. Installing 202 the SMP into the package may deform the SMP through contact with the interior wall(s) of the package.

In one embodiment, an SMP may be installed 202 into a package through extruding (e.g., deforming) the SMP into the package. In another embodiment, an SMP may be installed 202 into a package in a first-deformed shape and the SMP may be allowed to expand into a second-deformed state (e.g., via elastic recoil) into the shape defined by the interior wall(s) of the package. For example, the SMP may be installed 202 through delivering the SMP within a carrier and removing the carrier while the SMP is inside the package. In other words, after the SMP is deformed by the carrier, the SMP may be allowed to elastically recoil into contact with the package into a different shape (e.g., larger along one axis or dimension) than the shape defined by the carrier.

In one embodiment, the installation operation 202 may include building the package around the SMP. For example, the SMP may rest in part of the package and the SMP may be installed 202 in the package by assembling the rest of the package around the SMP. In another embodiment, the installation operation 202 may include forming a package around the SMP. For example, the SMP may be cooled to a storage temperature below an activation temperature and a package may be poured, molded or otherwise formed around the SMP. The formed package may include destructive elements which allow the package to be opened, such as wires formed into the package that may be pulled from the package to cut the package open.

After the SMP is installed 202 in the package, recovery is induced 204 in the SMP while in the package. The recovery may be induced 204 actively through intentionally activating the SMP, or passively through step(s) allowing the SMP to be activated, for example, as a result of the SMP being subjected to a rise in temperature. For example, an SMP may have an activation temperature which is near human body temperatures and therefore may be encountered regularly during shipping (e.g., 30-40 degrees Celsius). Therefore, recovery of an SMP may be induced 204 by the SMP being shipped and thereby exposed to environments which are not temperature controlled, and which heat the SMP to an activation temperature.

Inducing 204 recovery may include an intentional activation of the SMP. For example, the SMP may be sterilized in a process which causes the recovery of the SMP (e.g., through heating to a sterilizing temperature greater than the activation temperature). An SMP may be sterilized along with its package while the SMP is within the package through subjecting both the SMP and the package to a sterilization process. In an example where heat sterilization is used, an SMP with a transition temperature below or near a sterilization temperature will be activated by the sterilization process. Other sterilization processes may also activate an SMP, depending on the type of SMP and type of sterilization process.

As another example of intentionally inducing 204 recovery, the SMP may be intentionally recovered into a desired shape while inside the package. An SMP may be installed 202 into a package in a first shape which is different from a shape of a cavity inside the package (e.g., as defined by the inner wall(s) of the package). The SMP may then be induced 204 to recover and the SMP's shape may change to conform to the shape of the cavity inside the package. For example, an SMP may be deformed to a shape for ease of installation 202 into a package. The shape may be different from the shape of the cavity of the package, a shape which is desired for placing 206 the device inside a patient. The SMP may then be induced 204 to recovery, and thereby change shape to conform with the shape of the cavity of the package. The SMP will then be restrained in the desired shape by the package, and no further shape change will be permitted by the package.

Inducing 204 recovery in the SMP actively (e.g., intentionally) may be repeated and/or combined with inducing recovery in the SMP passively, which may also be repeated. For example, recovery may be induced 204 in order to change the shape of the SMP to a shape desired for placement 206 within a patient. After the shape change, the SMP may be sterilized, thereby inducing 204 another recovery. After the sterilization, the SMP may be transported without temperature control and may experience heating cycles during transport which induce 204 recovery of the SMP, possibly several more times.

Recovery is induced 204 as described above, the SMP is placed 206 in a patient. The placing 206 of the SMP in a patient can be performed through any surgical process including inserting, driving, installing, depositing, sliding, and/or delivering the SMP into the patient. The SMP may be placed 206 within a patient via placing a medical device containing the SMP within the patient.

In one embodiment, placing 206 can include translating the SMP along an axis which is at an angle to the intended expansion of the medical device. For example, a medical device may be inserted along an insertion axis into the patient, and the recovery of the SMP may cause the medical device to expand along an axis, or several axes, which is/are normal to the insertion axis. General surgical methods for placing devices and elements within a patient are known to those with skill in the art.

In one embodiment, the medical device can be placed within a bone of a patient along with a soft tissue member, such as a tendon graft or artificial tendon replacement. The medical device can fix the soft tissue member against the bone via expanding along an axis, as described above. The fixing of the soft tissue member may be useful in tendon/ligament repair surgeries in joints, such as anterior cruciate ligament repair surgeries in the knee joint. The medical device can fix the soft tissue against a bone by pressing itself to the bone and pressing the soft tissue to the bone. In some embodiments, the medical device may conform to the bone and soft tissue during the process of fixing itself and the soft tissue to the bone. For example, a medical device made completely out of SMP may conform to the bone and soft tissue during recovery inside the patient.

The SMP may be placed 206 within a patient while the SMP is in a shape defined by the package. As described further below, the SMP is removed from the package before it is placed in the patient and the SMP is not significantly recovered between being removed from the package and being placed 206 in the patient. Examples of additional steps are described below for removal of the SMP from the package and for ensuring that the SMP does not significantly recover during the time between removal from the package and placing 206 in the patient.

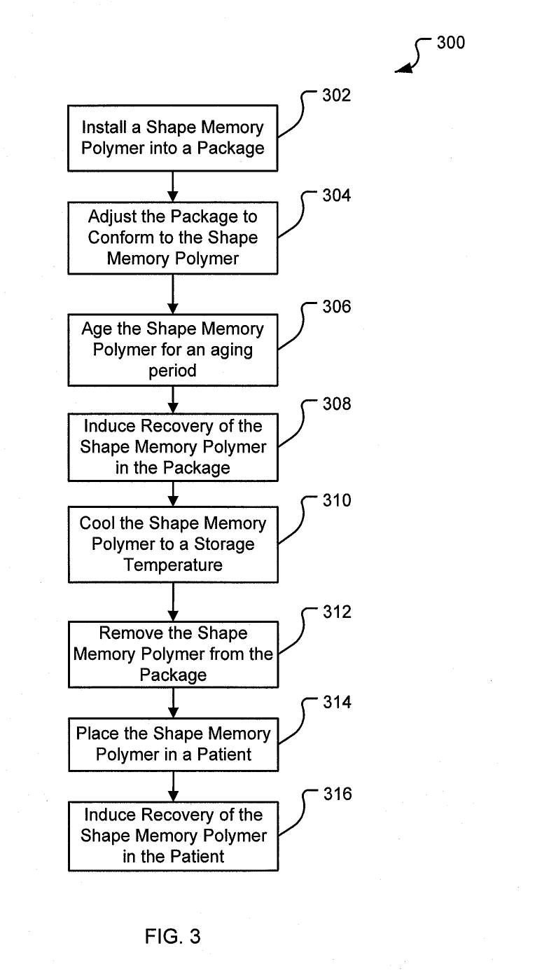

FIG. 3 shows a flow chart of an embodiment of a method 300 for storing and transporting a shape memory element under constraint. The embodiment shown includes installing 302 an SMP into a package designed to constrain the SMP against changing into an unusable shape during activation of the SMP, as described further herein.

The method 300 includes adjusting 304 the package to conform to the SMP. Adjusting 304 may, in some embodiments, be part of the installation 302, but is described separately in the embodiment shown for clarity. Adjusting 304 the package may be included in addition to the installing 302 of the SMP into the package.

In the embodiment shown, the package is adjusted 304 while the SMP is within the package. As an example, a package can be caused to deform (e.g., caused to shrink) and the package itself can exert a deforming force to the SMP. As another example, a package may be designed which can be deformed by an external force (e.g., compressed, crushed) with the SMP within the package, and the package can transfer deforming forces to the SMP. The adjustment 304 of the package may deform the SMP through, for example, reducing a dimension of the inner wall(s) of the package, thereby allowing the inner wall(s) to deform the SMP. A package may be adjusted along more than one dimension at a time. Adjusting 304 of a package may expand one dimension of the inner wall(s) and reduce another dimension of the inner wall(s).

Adjusting 304 the package may be required if the SMP is installed in a shape which is smaller (at least on one dimension) than the shape defined by the package. In one embodiment, adjusting 304 the package may include tightening an adjustable mechanism (e.g., a tightening locking cord) around the package. In another embodiment, adjusting 304 the package may be performed in steps, such as through tightening a mechanism along certain lock-steps (e.g., ratcheting along a series of teeth).

Mechanisms for adjusting 304 the package can include levers or other means of creating mechanical advantages known to those with skill in the art (e.g., similar to leverage mechanism common on mountaineering boots or ski boots). Mechanisms for adjusting 304 the package may include steps and/or stop-points which correlate to different predefined shapes of the inner wall(s) of the package, thereby allowing the rearrangement of the inner wall(s) to a particular shape by adjusting the package to a particular stop-point.

In one embodiment, the SMP is installed 302 before it is deformed. For example, the SMP may be installed 302 in an unconstrained shape at a deformation temperature that is higher than the storage temperature. The SMP may be deformed via adjusting 304 the package to impart the deformed shape on the SMP. For example, as described above, the package may be compressed, crushed, caused to shrink, or otherwise deformed into a shape that imparts the desired shape on the SMP. As another example, as described above, the package may have adjustable features, levers, and/or other mechanisms that allow the shape of the SMP to be adjusted with the adjustment of the package. In this embodiment, because the SMP is deformed while in the package, the SMP may remain above a storage temperature to lock in the deformed shape and thereby prevent shape change while being installed 302 into the package.

The method 300 includes aging 306 the SMP for an aging period while the SMP is in the package. In one embodiment, aging can include storage at a temperature that does not cause significant activation, and constraint can be applied through having the package engage the SMP with a pressure created without activation. In another embodiment, aging can include storage at a temperature that causes activation 206 against the package that constrains shape change in the SMP. In another embodiment, aging can also include storage at a temperature that causes significant activation 206, such as through subjecting the SMP to deliberate activating temperature cycles. In other words, the constraint applied by the package may apply various forces to the SMP to retain the shape of the SMP while the SMP is subjected to various controlled or uncontrolled activations 206.

Recovery of the SMP may be induced 308 during the aging period. The induced 308 recovery of the SMP inside the package is described further above. In some embodiments, the constraint can limit recovery of the SMP to the exertion of force against the constraint. In some embodiments, the constraint can limit recovery to a desired or acceptable shape change. In some embodiments, the constraint can limit recovery to a combination of exertion of force against the constraint and shape change.

In the embodiment shown, the SMP is cooled 310 while in the package. The cooling 310 is performed to a storage temperature which is below a temperature at which activation occurs. For example, cooling 310 may bring the SMP out of an activated state and cease recovery of the SMP. The cooling may be performed to ensure that any activations are stopped before the SMP is removed from constraint. Cooling 310 the SMP to a storage temperature allows the SMP to be removed 310 from the package, and from the constraint provided thereby, without an undesirable shape change occurring.

Cooling 310 the SMP reduces the recovery-related forces between the SMP and the package so that the release of these forces does not cause significant (e.g., undesirable) shape change when the SMP is removed 312 from the package. An SMP which has been cooled 310 may still exert forces against the package, and the release of the forces may cause some shape change which may be expected, planned for, and otherwise acceptable. As described further herein, storing the SMP under pressure within the package can be used as part of the aging 306 process. Cooling 310 may be performed before the aging period (e.g., to a storage temperature at which the SMP is held for the aging period) and/or afterwards, as shown.

Storage temperatures may be selected based on the rate of recovery (e.g., none, slow) which is acceptable for the time period which the SMP will be unconstrained. The storage temperature to which an SMP is cooled 310 before removal 312 need not be the same as any other storage temperature. For example, a first storage temperature to which an SMP is initially cooled after deformation and/or during installation 302 need not be the same temperature as a storage temperature to which the SMP is cooled 310 before the SMP is removed 312 from constraint and placed 314 into a patient.

A rate of recovery that is acceptable for a period of time between deformation and constraint (e.g., during installation 302) may be different from a rate of recovery acceptable for a period of time between releasing from constraint (e.g., removing 312) and placing within a patient 314. For example, the respective time periods may be substantially different lengths. As another example, manufacturing tolerances for fitting into a package, storage, and/or being transported may be stricter than tolerances for placing into a patient. In other words, recovery through shape change during removal 312 of the SMP from constraint and placing in the patient may be more or less controlled. Therefore, different storage temperature requirements may exist, depending on how important the lack of recovery is while the SMP is not constrained.

Removing 312 the SMP from the package can include release mechanisms which allow an element to be easily removed from the package, even though the package is designed to withstand forces of activations of the SMP. As examples, locking mechanism 106 is shown in FIG. 1A and destructive element 124 is shown in FIG. 1B.

As described above, a package may be exerting a force on the SMP, even after the SMP is cooled 310. Releasing the forces may be aided by a release mechanism so that the package only opens when it is appropriate to do so. For example, a release mechanism can rupture a part of the package, allowing dismantling of the package. A release mechanism may make the package easily susceptible to an opening force other than a force caused by the activation of the SMP. For example, a release mechanism may be part of a package and be easily ruptured by a force in a twisting direction applied to the package (e.g., opening a locking mechanism). A release mechanism may use any manner of leverage to multiply an opening force applied by a person who wishes to open the package.

Placing 314 the SMP in a patient has already been described with respect to FIG. 2. As a result of placing 314 the SMP in a patient, the SMP may receive heat from the patient. For example, an SMP may come in contact with the patient through placing the SMP in the patient. As another example, an SMP which is only part of the medical device may receive heat from a patient through other parts of the medical device. If the SMP is cooler than the patient, the SMP will receive heat from the patient, directly or indirectly, until it equilibriates with the patient's body temperature.

In the method 300, the SMP is induced 316 to recover inside the patient. For example, a patient's body temperature (and specifically the temperature of the patient's body surrounding the installation site) may be greater than the temperature of the SMP before it comes in contact with the patient. The temperature differential will cause heat to be transferred to the SMP, thereby inducing 316 recovery of the SMP within the patient. For example, if the SMP receives heat from a patient, the heat received can contribute to inducing 316 recovery the SMP inside the patient. Heat may be transferred to the SMP from other sources of heat and/or energy, such as a warm saline bath, a heating element, and/or electromagnetic radiation. Recovery may be induced 316 based on heat received from multiple sources in combination, such as heat from the patient and heat from an external heating source.

Recovery may be induced 316 based on different sources of heat during different parts of the SMP's recovery inside a patient. For example, an SMP may receive heat from a patient for an initial heating and activating phase. The SMP may then be heated with a heating source (e.g., liquid bath) for a second phase of recovery. For example, a second phase of recovery can include a higher rate of recovery to quickly change the shape of the SMP and deploy the medical device within the patient. The SMP may then continue to be heated (or may start to be cooled) by the patient through a third phase of recovery. For example, after the external heating source is removed, the patient may continue to supply heat to the SMP (or receive heat from the SMP), thereby affecting the SMP through a third phase of recovery. The SMP may continue to recover through the third phase of recovery without the external heating source for a period of time while the surgery is completing, and possibly after the surgery is completed.

In one embodiment, the SMP may have a transition temperature that is near or below human body temperature so recovery at acceptable rates may be possible using heat from a human patient exclusively. In another embodiment, additional heat from an external heating source may be used in order to control the rate of recovery of the SMP while inside the patient. For example, a faster heating of the SMP may result in a faster recovery of the SMP, due to a quicker rise in temperature.

In another embodiment, an SMP has an activation temperature that is higher than human body temperature so that activation and recovery may be possible at only slow rates, using heat from a human patient exclusively. Additional from an external heating source, heat may be used to speed up the rate of recovery or otherwise control the rate of recovery of the SMP while in the patient.

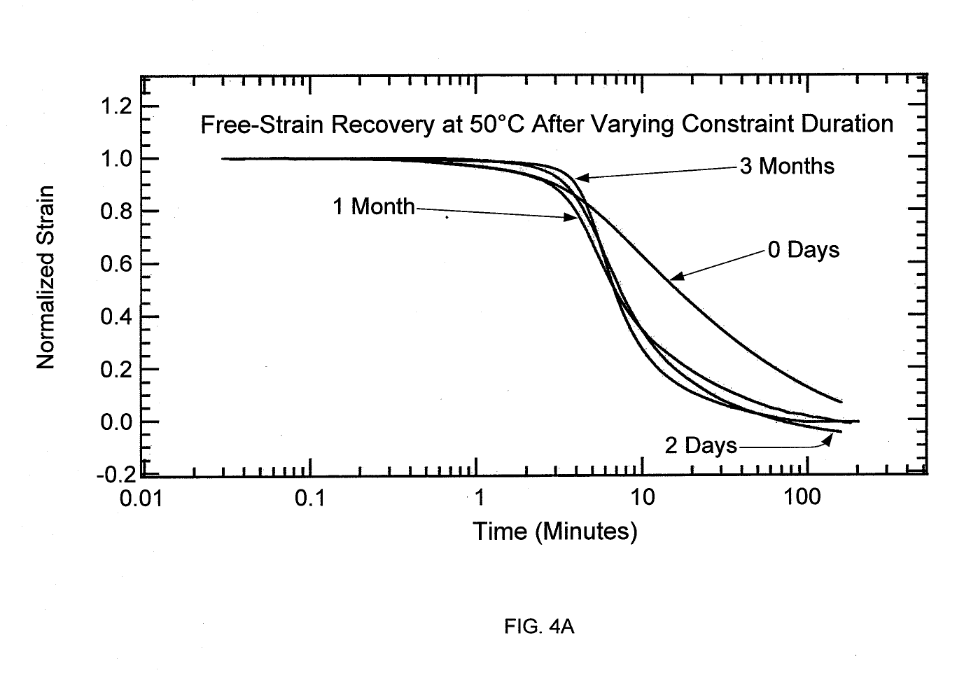

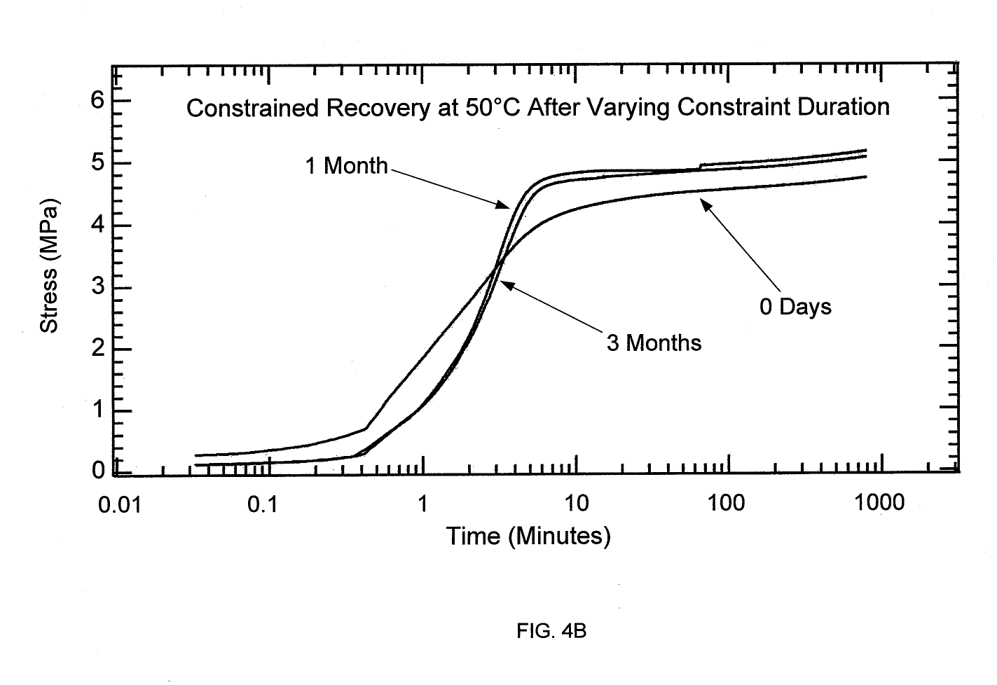

FIG. 4A shows experimental data of free-strain recovery of shape memory polymers with varying durations of constraint. The SMPs in experiments were composed of about 45% PEG-DMA by weight with the balance (e.g., about 55% by weight) of MMA and a sufficient amount of photo-initiator (about 1% by weight). The SMPs were held under constraint at a fluctuating room temperature for zero (0) days, two days, one month, and three months, respectively. The holding under constraint for a period of time through which the SMP is exposed to fluctuating temperatures is an example of an aging process. The constraint was a c-clamp (e.g., a clamp with a c-shaped frame and an adjustable screw used to close the clamp) which held the SMP and limited expansion of the SMP against the frame and screw (e.g., along the axis of the frame).

The room temperature fluctuated during the aging process due to random, uncontrolled variations of the room temperature. The SMP was not subjected to any intentional temperature cycles to cause recovery. Nominally, the average room temperature was about 20 degrees Celsius. The transition temperature of the SMP was 71 degrees Celsius with a broad-to-moderate transition, due to the SMP's high cross-linking density. Therefore, the average room temperature was below the activation temperature of the SMP. Fluctuations of the temperature during the aging process may have caused one or more periods of slight-to-moderate activation of the SMP.

The four graph lines in FIG. 4A plot free-strain recovery (or shape change due to activation without constraint) of SMPs recovered after the specified aging periods. The lines are plotted as normalized strain as a function of time. In terms of normalized strain, 1.0 represents 100% stored strain (e.g., the shape constrained by the packaging), and 0.0 represents 0% stored strain. The stored strain in the experiments included compression along the same axis as the constraint imposed by the c-clamps during the aging period. The SMPs were recovered in a water bath of 50 degrees Celsius. Therefore, the water bath used was below the transition temperature of the polymer. However, the activation temperature of the polymer was exceeded in the SMPs. This was accomplished through heat transfer from the water bath. The significant recovery of the SMPs (e.g., greater than 20% recovery within 2 hours) is shown by the graphs. For example, each of the SMPs with a non-zero aging period achieved a 50% strain recovery in about 6 minutes.

A water bath is an example of an environment with little or no constraint. Other examples of suitably “constraint-free” environments in which to test free-strain recovery include the marginal constraints caused by the use of instrumentation and normal gravitational forces on the SMPs.

The four plot lines in FIG. 4A show an aging effect on an SMP from storage under constraint. Specifically, there is a significant change in free-strain recovery plots between constraint durations of zero days and two days. Further constrained aging produces relatively less change in the recovery plots. Thus, in contrast to the teachings of the prior art, aging an SMP under constraint may be beneficially used to stabilize the free-strain recovery response of the SMP and alter the recovery rate. For example, the aging under constraint of SMPs can be used to ensure consistent deployment of medical devices containing the SMPs during surgery and also reduce the time required for a surgeon to place and recover a medical device during surgery on a patient.

FIG. 4B shows experimental data of constrained recovery of shape memory polymers with varying durations of constraint. The experimental setup and SMP properties for the experiments in FIG. 4B are the same as to those described above for FIG. 4A. However, the three graph lines in FIG. 4B plot the force developed by the SMP due to activation under constraint. The lines are plotted as pressures (or force-per-unit area) developed against a load cell such as those sold by Instron of Norwood, Mass. The SMPs were recovered in a water bath of 50 degrees Celsius while being constrained by the load cell and the force exerted by the SMP was measured by the load cell.

The constrained recovery plotted by the three graph lines show pressures generated by the SMP in mega pascals (MPa). The pressures generated indicate the recovery of an SMP without commensurate shape change. A package designed to withstand recovery without commensurate shape change would be able to successfully withstand the stresses generated.

In FIG. 4B, there are three graph lines showing data of SMPs held under constraint at for zero (0) days, one month, and three months, respectively. The three plot lines in FIG. 4B show an aging effect on the constrained recovery properties of an SMP. Specifically, there is a significant change in pressure plots between constraint durations of zero days and one month. The other difference in constraint durations (e.g, from one month to three months) produces relatively less change in the recovery plots. Thus, in contrast to the teachings of the prior art, aging an SMP under constraint may be beneficially used to stabilize the constrained recovery response of the SMP. In addition, in the experimental tests, the aging period under constraint also increased the stress exerted by the SMP, thereby making it more effective for some applications.

Because recovery can include both shape change and the development of forces against constraint, the aging effects shown in FIGS. 4A and 4B may combine to provide consistent overall recoveries in SMPs (e.g., recoveries which include both shape change and development of forces). In some embodiments, the aging period may include periods of uncontrolled activation. In other embodiments, the aging period may include periods of intentional and/or controlled activation of the SMP. Packages designed to withstand recovery of SMPs without commensurate undesireable shape change can be used to age SMPs using the methods described herein. Therefore, SMPs packaged in such packages and treated by the methods herein can yield more consistent recovery responses when recovered, for example, in a patient.

Unless otherwise indicated, all numbers expressing quantities of ingredients, and properties such as percentages, temperatures, time periods, pressures, and so forth used in the specification and claims are to be understood as being modified in all instances by the term “about.” Accordingly, and unless indicated to the contrary, the numerical parameters set forth in this specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The methods and systems described herein as embodiments relating to medical devices are broadly applicable to other devices. For example, a method for controlling undesirable shape change in a medical device may also be used for other devices, such as any appropriate mechanical device (e.g., hardware, fasteners). In addition, aging processes may be beneficially used for the effects of consistent and faster recovery processes with other devices apart from medical devices.

The descriptions of the methods and systems herein supplement each other and should be understood by those with skill in the art as forming a cumulative disclosure. Methods and systems, though separately claimed herein, are described together within this disclosure. For example, the parts of the methods described herein may be performed by systems (or parts thereof) described herein. In addition, the methods described herein may be performed iteratively, repeatedly, and/or in parts, and some of the methods or parts of the methods described herein may be performed simultaneously.

What is claimed is:

1. A method of preparing and deploying in surgery a shape memory polymer, the method comprising:
installing into a package a shape memory polymer in a first shape at a first storage temperature below a transition temperature of the shape memory polymer;
after installing, allowing the shape memory polymer to approach the transition temperature;
constraining by the package the shape memory polymer in the first shape; and
inserting the shape memory polymer in the first shape at a second storage temperature into a patient at an insertion site in the patient with an insertion temperature greater than the second storage temperature.

2. The method of claim 1, wherein the insertion temperature is below the transition temperature.

3. The method of claim 2, further comprising:
after inserting, heating the shape memory polymer while inside the patient.

4. The method of claim 3, wherein heating is selected from flooding the insertion site with a saline bath, contacting the shape memory polymer with an external heating element, and exposing the shape memory polymer to electromagnetic radiation.

5. The method of claim 1, wherein the first storage temperature is different from the second storage temperature.

6. The method of claim 1, further comprising:
inducing recovery of the shape memory polymer into a second shape while in the patient, thereby fixing the shape memory polymer relative to a bone of the patient.

7. The method of claim 1, further comprising:
deforming the shape memory polymer; and
wherein the deforming and the installing are performed as a single operation.

8. A method of aging a shape memory polymer in a medical device, the method comprising:
installing a medical device containing a shape memory polymer in a deformed shape into a package adapted to constrain the medical device against shape change during activation of the shape memory polymer;
aging the shape memory polymer in the package for an aging period;
during the aging period, inducing recovery of the shape memory polymer within the package;
after aging the shape memory polymer, removing the medical device from the package; and
inducing recovery of the shape memory polymer in a patient.

9. The method of claim 8, wherein inducing recovery of the shape memory polymer within the package includes heating the shape memory polymer.

10. The method of claim 9, further comprising, after inducing recovery of the shape memory polymer within the package, and before removing the medical device from the package:
cooling the shape memory polymer to below an activation temperature of the shape memory polymer.

11. The method of claim 8, further comprising:
placing the medical device in the patient.

12. A method of providing a shape memory polymer for use at a surgery site, the method comprising:
installing a shape memory polymer which is in a deformed shape into a package adapted to prevent the shape memory polymer from changing into a recovered shape if the shape memory polymer approaches a transition temperature of the shape memory polymer; and
inducing recovery of the shape memory polymer in the package.

13. The method of claim 12, wherein the recovered shape requires a deformation before use during a surgical procedure.

14. The method of claim 12, further comprising:
sterilizing the shape memory polymer; and
sterilizing the package.

15. The method of claim 12, further comprising, after installing the shape memory polymer in the package:
sterilizing the shape memory polymer; and
sterilizing the package.

16. The method of claim 12, further comprising:
removing the shape memory polymer from the package.

17. The method of claim 16, further comprising:
after removing, placing the shape memory polymer in a patient.

18. The method of claim 17, further comprising:
inducing recovery of the shape memory polymer while in the patient into a third shape which conforms to a soft tissue and to a bone of the patient.

19. The method of claim 16, wherein removing the shape memory polymer from the package comprises:
operating a release mechanism included in the package.

20. The method of claim 19, wherein operating the release mechanism at least partially opens the package.

21. The method of claim 19, wherein operating the release mechanism removes contact between at least part of the package and at least part of the shape memory polymer.

22. The method of claim 19, wherein operating the release mechanism comprises:
applying an incremental operating force to a part of the release mechanism.

23. The method of claim 12, wherein inducing recovery of the shape memory polymer comprises:
allowing the shape memory polymer to approach a transition temperature of the shape memory polymer.

24. The method of claim 12, further comprising:
adjusting the package to conform to the shape memory polymer in the first shape.

25. The method of claim 24, wherein adjusting is performed before inducing recovery of the shape memory polymer in the package.

26. The method of claim 24, wherein adjusting the package comprises:
collapsing the package against the shape memory polymer.

27. The method of claim 24, wherein adjusting the package comprises:
tightening an adjustable element of the package.

28. The method of claim 24, wherein the package after adjustment contacts a first portion of the shape memory polymer in the first shape.

29. The method of claim 24, further comprising:
deforming the shape memory polymer within the package.

30. The method of claim 29, wherein the deforming the shape memory polymer and the adjusting the package are performed as a single operation.

31. The method of claim 12, wherein the package defines a surgery installation shape, the method further comprising:
inducing recovery of the shape memory polymer into the surgery installation shape.

32. A kit comprising:
a first shape memory polymer in a deformed shape; and
a package adapted to constrain the first shape memory polymer to prevent the first shape memory polymer from changing into a recovered shape different from the deformed shape if the first shape memory polymer is activated.

33. The kit of claim 32, wherein the first shape memory polymer is within the package.

34. The kit of claim 32, further comprising:
a second shape memory polymer.

35. The kit of claim 34, wherein the second shape memory polymer is within the package.

36. The kit of claim 34, wherein the second shape memory polymer is in an alternate deformed shape different from the deformed shape of the first shape memory polymer.

37. The kit of claim 36, wherein the package is further adapted to constrain the second shape memory polymer to prevent the second shape memory polymer from changing into a second recovered shape different from the alternate deformed shape if the second shape memory polymer is activated.

38. The kit of claim 36, wherein the alternate deformed shape is a scaled version of the deformed shape of the first shape memory polymer.

39. The kit of claim 38, wherein the alternate deformed shape is scaled along one dimension of the deformed shape of the first shape memory polymer.

40. The kit of claim 32, further comprising:
a sterile tool for extracting from the first shape memory polymer from within the package.

41. The kit of claim 40, wherein the sterile tool is selected from a hex key, and a lever.

42. The kit of claim 40, wherein the sterile tool is adapted for use in installing the first shape memory polymer into an installation site in a patient.
